(19) United States
(12) Patent Application Publication
(10) Pub. No.: US 2011/0297764 A1
(43) Pub. Date: Dec. 8, 2011

(54) De-Icer for Airplanes

(76) Inventor: Elo Svanebjerg, Tappernoeje (DK)

(21) Appl. No.: 13/132,648

(22) PCT Filed: Dec. 5, 2008
(86) PCT No.: PCT/IB08/03367

§ 371 Date: Aug. 25, 2011

(51) Int. Cl. B64F 5/00

(52) U.S. Cl. 239/722

(57) ABSTRACT

De-icer for airplanes, comprising a self-propelled vehicle (3) provided with a lifting device in the form of a first boom (2) pivoting around a base-near pivot (11) and being active in a longitudinal vertical plane forward of the pivot (11). The boom (2) is connected to a spraying platform (10) via a connection mechanism (8) maintaining a horizontal position of the platform floor. A spray gun (12) is mountable on the platform (10) and connected to a tank assembly (6) arranged substantially above and to the rear of the rear wheel axle (7), including deicing and/or anti-icing fluid tanks (6), heating means (4) for the fluids, and corresponding pumps (5) and piping (13) connecting the pumps (5) and the spray gun (12).

The present invention relates to de-icers for airplanes, comprising a vehicle provided with a lifting device in the form of an operator's platform mounted at the end of interconnected booms and capable of positioning the operator in the required positions for the de-icing operation.

In airports with winter conditions for all or part of the year, de-icers are required for the safety of air traffic. For the sake of safe take-offs, airplanes have to have their wing surfaces cleaned from ice and snow formations (de-icing) and immediately thereafter, the same wings have to be prepared (anti-icing) to protect them against new layers of precipitations such as snow and ice, to ensure that the airplanes have clean wings during take-off.

The de-icers are usually very large for servicing large aircraft in short period of time but at the expense of manoeuvrability. Smaller airplanes require smaller de-icing equipment with a fine tuned manoeuvrability coming primarily from a vehicle with a short wheelbase. Only if the vehicle has such manoeuvrability, the de-icing operations on especially smaller airplanes can be completed in a swift and timesaving manner.

A disadvantage of a de-icer vehicle having a short wheelbase is the question of ensuring, in use, a high level of stability when driving with the lifting gear in a raised position. Usually a de-icer vehicle with a low level of stability would require stabilization thereof, e.g. activated supporting legs while the lifting device is operated, possibly having one or two operators standing on the platform and thereby raising the centre of mass. The fact that the lifting device does not need to be lowered when changing position, means a lot in terms of timesaving.

A de-icer according to the invention does not have such disadvantages in that it comprises a self-propelled vehicle provided with a lifting device in the form of a first boom pivoting around a base-near pivot and being active in a longitudinal vertical plane forward of the pivot, said arm having connected thereto a spraying platform via a connection mechanism maintaining a horizontal position of the platform floor. A spray gun is mountable on the platform and connected to a tank assembly arranged substantially above and to the rear of the rear wheel axle, including de-icing and/or anti-icing fluid tanks, heating means for the fluids, and corresponding pumps and piping.

De-icers are normally seen with the pivot point of their boom being arranged on top of the vehicle in order to reach larger aircraft, while the de-icer according to the invention obtains a favourable stability by the boom pivot point and consequently also the centre of mass being near the base of the vehicle; in fact near the rear wheel axle.

Moreover, the tank assembly being centred above or near the rear axle likewise adds to the stability by the load thereof.

This stability feature also adds to the capability of precisely driving the de-icer around a target airplane, while the platform is manned, which is not recommended for prior art operator's platforms with a low level of stability.

According to another feature of the invention, the lifting device being constituted of a telescopic first boom and the platform also comprises a second boom arm connected to the platform at one end thereof and at the opposite end to the connection mechanism allowing the second boom arm a range of movement going ±90° relative to the longitudinal direction of the first boom. The mechanism is provided with levelling means maintaining the platform floor constantly in the horizontal position.

Further, the first boom moves between a 6 o′clock and a 10 o′clock position in a central vertical plane only, thereby avoiding an increase in lateral momentum, which could otherwise contribute to instability when the platform and the second boom arm swing away from said longitudinal direction.

A further feature is the provision of control devices on the platform for an onsite operator to take full control of the lifting device and the spraying installation, and according to still another feature, steering devices for driving the vehicle can be operated from the platform. One or two operators are able to run all operations from the platform.

Also, the de-icer has pumps and heating means being part of the tank assembly and arranged on one or either side of the pivot end of the first boom and thereby counterbalancing the load of the lifting device.

Furthermore, the de-icer has fluid tank(s) arranged to the rear of the rear axle, said tank(s) being part of the tank assembly and counterbalancing the load of the lifting device.

Furthermore, in another embodiment of the invention said two parts of the tank assembly have changed positions, whereby the balance of the de-icer is not negatively influenced by the decreasing level of fluid in the tanks concurrently with the ongoing spraying operation, because the tank(s) are positioned right above the wheel axle.

In another embodiment tanks have bottoms sloping away from the axle in a longitudinal direction of the vehicle, the configuration being such that the contribution to the momentum will be close to constant while dispensing the fluid.

The de-icer according to the invention addresses the need for equipment to service smaller airplanes in a swift manner by being able to manoeuvre nearby and around the airplanes due to a very modest turning radius and to the operability from the platform and in that way reducing the duration of the de-icing operation.

Use can be made of a standard self-propelled vehicle as a de-icer base, said vehicle having a wheeled base with a telescopic boom mounted low on the base and moving up and down in a vertical plane following the longitudinal centre line of the vehicle. Using a standard self-propelled vehicle as the backbone of the de-icer allows of considerable savings and cheaper sales prices for the benefit of the customers.

The invention will be better understood from the examples described in further details below and with reference to the drawings showing:

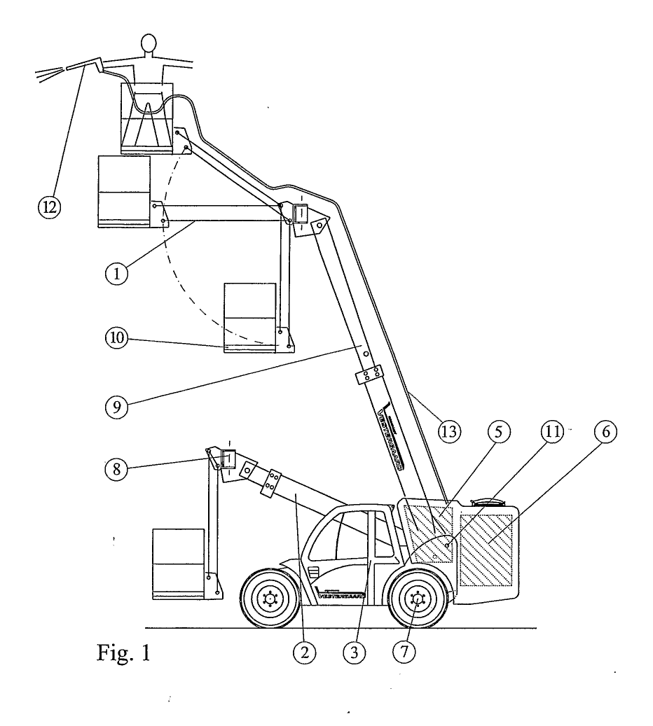

FIG. 1 a side view of a de-icer according to the invention, having a platform in different positions,

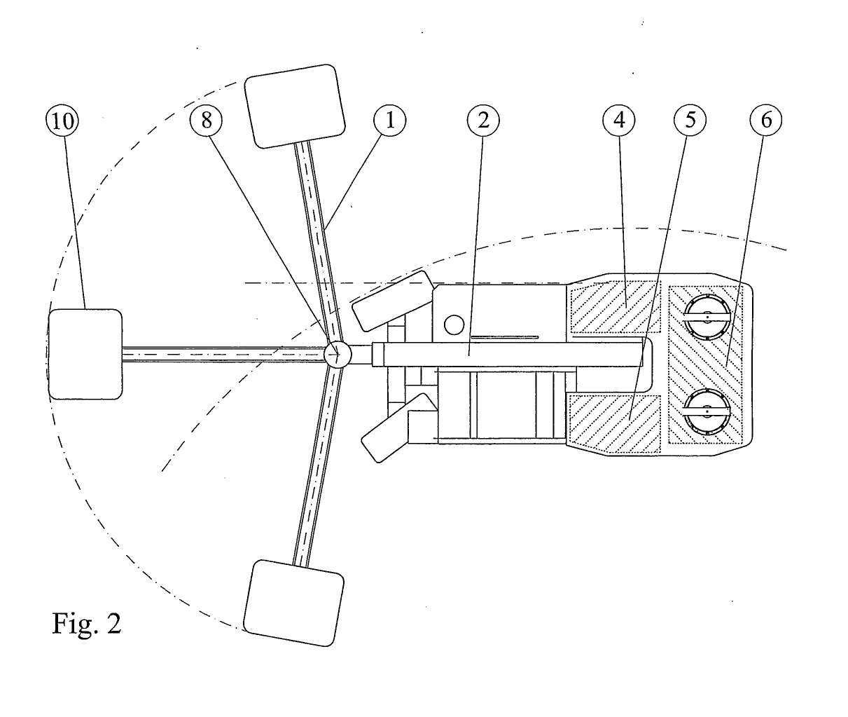

FIG. 2 a plan view of the de-icer of FIG. 1,

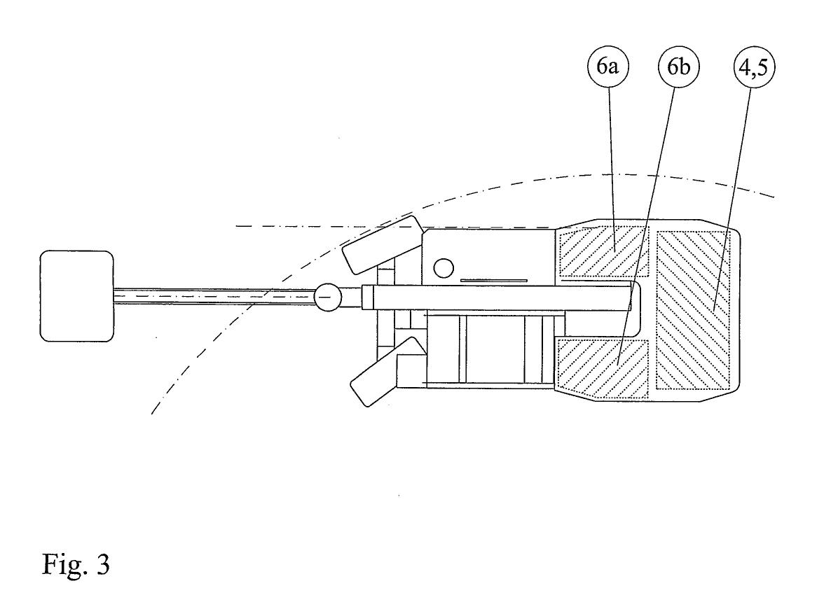

FIG. 3 a plan view of a second embodiment of a de-icer according to the invention, wherein the two parts of the tank assembly have changed positions, and

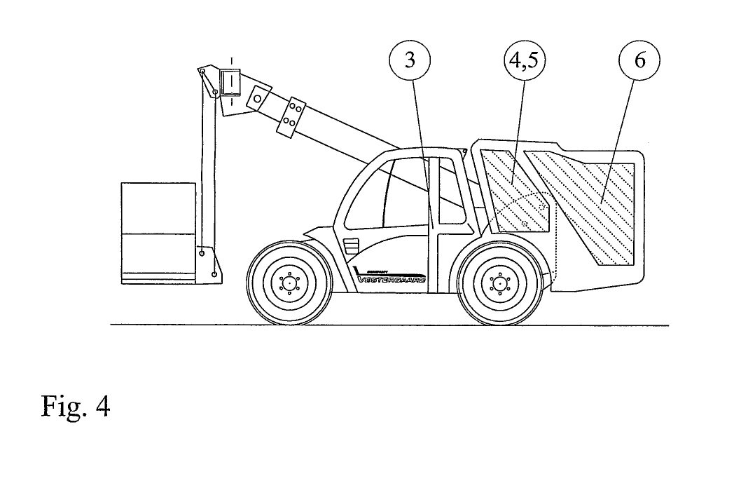

FIG. 4 a side view of the second embodiment of a de-icer according to the invention.

FIG. 1 shows a first embodiment of a de-icer according to the invention, wherein a self-propelled vehicle 3 having an operator's platform 10 attached to one end of a first boom arm 1, moves on wheels, whereof the rear wheel axle 7 is situated substantially beneath the pivot point (11) of a telescopic boom 2 having an extendible second boom arm 9. The free end of the second boom arm 9 is provided with a connection mechanism 8 connecting the boom arm 9 to an operator's platform 10 through the first boom arm 1.

Moreover, as shown in FIGS. 1 and 2 the connection mechanism 8 includes levelling means to ensure a constantly horizontal position of the platform 10 for the operator(s) to work safely thereon. The connection mechanism 8 allows of the platform to be moved vertically to any position between a 6 o′clock and a 10 o′clock position relative thereto; and 90° to each side of the longitudinal direction of the boom 2, and consequently the vehicle 3. This makes it possible for a spraying operator to get very near to especially small airplanes and thereby performing an economical and efficient operation.

The platform 10 has enough work space for one or two operators with spray guns and has also control devices for full operation of the lifting device from the platform. Moreover, in an advantageous embodiment of the invention the platform is provided with control devices for the operators to drive the vehicle while standing on the platform 10, thereby saving valuable time.

In order to always ensure a high level of stability of the vehicle 3 the lifting device is counterbalanced by the load of the tank assembly being positioned in an optimal way relative to the rear axle 7.

In one of the preferred embodiments (FIG. 4) one part of the tank assembly, comprising heating means 4 and pumps 5, is arranged in a saddleback manner laterally of the pivot 11 end of the telescopic boom 2 and substantially above the rear axle 7, while a second part of the tank assembly comprising de-icing and/or anti-icing fluid tanks, is arranged to the rear of the rear axle 7.

In another preferred embodiment (FIG. 3) the two parts of the tank assembly are arranged in opposite position compared to the previous embodiment.

One way of fighting possible instability due to decreasing load of the contents of the tanks as the spraying operation is active can be having tanks formed with bottoms sloping away from the rear axle, whereby the momentum relative to the rear axle 7 is kept constant because the distance of the centre of mass from the rear axle increases as the mass (and level of fluid) decreases.

### REFERENCE LIST

1. Second boom arm

2. First boom

3. Vehicle

4. Heating means

5. Pumps

6, 6a, 6b. Tank(s)

7. Rear wheel axle

8. Connection mechanism with vertical levelling mans

9. Second, extendible arm of the first boom 2

10. Platform

11. Pivot point

12. Spray gun

13. Piping

1. De-icer for airplanes, comprising a self-propelled vehicle provided with a lifting device in the form of a first boom pivoting around a base-near pivot and being active in a longitudinal vertical plane forward of the pivot, said boom having connected thereto a spraying platform via a connection mechanism maintaining a horizontal position of the platform floor, whereby a spray gun is mountable on the platform and connected to a tank assembly arranged substantially above and to the rear of the rear wheel axle, including de-icing and/or anti-icing fluid tanks, heating means for the fluids, and corresponding pumps and piping connecting the pumps and the spray gun.

2. De-icer according to claim 1, wherein the lifting device constituted by the platform and the first boom having an extendible first boom arm connected to the connection mechanism, allows the platform to assume any vertical position between a 6 o′clock and a 10 o′clock position relative to the connection mechanism.

3. De-icer according to claim 1, wherein the platform and a second boom arm connecting the platform to the connection mechanism, are able to swing up to ±90° relative to the longitudinal direction of said first boom in a horizontal plane.

4. De-icer according to claim 1, wherein the connection mechanism includes levelling means maintaining its swing axis constantly vertical.

5. De-icer according to claim 1, the platform having work space for one or two operators with spray guns, and having control devices for full operation of the lifting device and the spraying installation.

6. De-icer according to claim 5, the platform further having steering devices for driving the vehicle.

7. De-icer according to claim 1, the de-icer having pumps and heating means arranged on one or either side of the pivot end of the first boom, said means counterbalancing the load of the lifting device.

8. De-icer according to claim 1, the de-icer having fluid tank(s) arranged to the rear of the rear axle, said tank(s) being part of the tank assembly and counterbalancing the load of the lifting device.

9. De-icer according to claim 7, the de-icer having the two parts of the tank assembly changing positions.

10. De-icer according to claim 8, wherein the tank(s) have bottoms sloping away from the axle in a longitudinal direction of the vehicle.
